(19) United States
(12) Patent Application Publication
(10) Pub. No.: US 2025/0285066 A1
(43) Pub. Date: Sep. 11, 2025

(54) INFORMATION PROCESSING METHOD, INFORMATION PROCESSING SYSTEM, AND RECORDING MEDIUM

(71) Applicant: Panasonic Intellectual Property Management Co., Ltd., Osaka (JP)

(72) Inventors: Kotaro SAKATA, Osaka (JP); Tetsuji FUCHIKAMI, Osaka (JP)

(21) Appl. No.: 19/219,152

(22) Filed: May 27, 2025

Related U.S. Application Data
(63) Continuation of application No. PCT/JP2023/036084, filed on Oct. 3, 2023.

(30) Foreign Application Priority Data
Dec. 13, 2022 (JP) 2022-198557

(51) Int. Cl. G06Q 10/0639

(52) U.S. Cl. CPC G06Q 10/06393

(57) ABSTRACT

An information processing method includes: obtaining evaluation target information containing information about an evaluation target; obtaining evaluator information containing information about an evaluator; determining, based on the evaluation target information and the evaluator information, at least one of a field expertise level or a conflict of interest level of the evaluator on the evaluation target; and deriving a confidence level of the evaluation based on the at least one of the field expertise level or the conflict of interest level which have been determined in the determining.

### CROSS REFERENCE TO RELATED APPLICATIONS

This is a continuation application of PCT International Application No. PCT/JP2023/036084 filed on Oct. 3, 2023, designating the United States of America, which is based on and claims priority of Japanese Patent Application No. 2022-198557 filed on Dec. 13, 2022. The entire disclosures of the above-identified applications, including the specifications, drawings and claims are incorporated herein by reference in their entirety.

### FIELD

The present disclosure relates to an information processing method, an information processing system, and a recording medium.

### BACKGROUND

Patent Literature (PTL) 1 discloses an evaluation support device that is capable of eliminating a prejudiced evaluation to support a proper evaluation of a person or a thing. This evaluation support device is provided with an evaluation point input means for inputting an evaluation point for an evaluation target by an evaluator, a deviation value calculating means for calculating the deviation value of the evaluation point input by the evaluation point input means, a correlation value calculating means for calculating the correlation values between the deviation value calculated by the deviation value calculating means and a given value, and an evaluator information output means for outputting evaluator information about an evaluator corresponding to the minimum correlation value among the correlation values calculated by the correlation value calculating means.

### CITATION LIST

### Patent Literature

PTL 1: Japanese Unexamined Patent Application Publication No. 2003-196432

### SUMMARY

### Technical Problem

However, expertise and the like of evaluators occasionally cause changes in evaluation results in conventional devices. For this reason, questions have been raised about the evaluation results provided by the evaluators.

The present disclosure provides an information processing method and the like that are capable of obtaining a confidence level of an evaluation that is to be performed or has been performed on an evaluation target by an evaluator.

### Solution to Problem

An information processing method according to one aspect of the present disclosure is an information processing method of deriving a confidence level of an evaluation that is to be performed or has been performed on an evaluation target by an evaluator. The information processing method includes: obtaining evaluation target information containing information about the evaluation target; obtaining evaluator information containing information about the evaluator; determining, based on the evaluation target information and the evaluator information, at least one of a field expertise level or a conflict of interest level of the evaluator on the evaluation target; and deriving the confidence level of the evaluation based on the at least one of the field expertise level or the conflict of interest level which have been determined in the determining.

An information processing system according to one aspect of the present disclosure is an information processing system that derives a confidence level of an evaluation that is to be performed or has been performed on an evaluation target by an evaluator. The information processing system includes: a target information obtainer that obtains evaluation target information containing information about the evaluation target; an evaluator information obtainer that obtains evaluator information containing information about the evaluator; a level determiner that determines, based on the evaluation target information and the evaluator information, at least one of a field expertise level or a conflict of interest level of the evaluator on the evaluation target; and a confidence level deriver that derives the confidence level of the evaluation based on the at least one of the field expertise level or the conflict of interest level which have been determined by the level determiner.

A recording medium according to one aspect of the present disclosure is a non-transitory computer-readable recording medium for use in a computer. The recording medium has recorded thereon a computer program for causing the computer to execute the above-described information processing method.

### Advantageous Effects

An information processing method and the like according to one aspect of the present disclosure can obtain a confidence level of an evaluation that is to be performed or has been performed on an evaluation target by an evaluator.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an information processing system according to an embodiment.

FIG. 2 is a block diagram illustrating a configuration of the information processing system according to the embodiment and an information processing device included in the information processing system.

FIG. 3 is a diagram illustrating one example of evaluation target information obtained by the information processing device.

FIG. 4 is a diagram illustrating one example of evaluator information obtained by the information processing device.

FIG. 5 is a diagram illustrating one example of a field expertise level determined by the information processing device.

FIG. 6 is a diagram illustrating one example of a conflict of interest level determined by the information processing device.

FIG. 7 is a diagram illustrating one example of a confidence level derived by the information processing device.

FIG. 8 is a flowchart illustrating an information processing method according to the embodiment.

FIG. 9 is a block diagram illustrating a configuration of an information processing system according to a variation of the embodiment.

FIG. 10 is a flowchart illustrating an information processing method according to the variation of the embodiment.

### DESCRIPTION OF EMBODIMENTS

An information processing method according to the present disclosure is a method of obtaining a confidence level of an evaluation that is to be performed or has been performed on an evaluation target by an evaluator.

The evaluation target is a matter subject to evaluation, and is, for example, a theme of research and development on which a company that an evaluator belongs to invests for the future. The evaluation target may include a project developed by members from a plurality of organizations, a group activity within an organization, a target theme developed by an individual, etc.

The evaluator is a person who evaluates the evaluation target. The evaluator evaluates the evaluation target depending on, for example, the business contribution level and technical strength of the evaluation target. Since resources (staff members, goods, property, etc.) are invested on the evaluation target depending on an evaluation result, the confidence level of an evaluation that is to be performed or has been performed on the evaluation target by an evaluator is required.

An information processing method according to the present disclosure includes the following steps, etc., to obtain a confidence level of an evaluation that is to be performed or has been performed on an evaluation target by an evaluator.

An information processing method according to example 1 is an information processing method of deriving a confidence level of an evaluation that is to be performed or has been performed on an evaluation target by an evaluator. The information processing method includes: obtaining evaluation target information containing information about the evaluation target; obtaining evaluator information containing information about the evaluator; determining, based on the evaluation target information and the evaluator information, at least one of a field expertise level or a conflict of interest level of the evaluator on the evaluation target; and deriving the confidence level of the evaluation based on the at least one of the field expertise level or the conflict of interest level which have been determined in the determining.

As described above, at least one of a field expertise level or a conflict of interest level of an evaluator on an evaluation target is determined based on evaluation target information and evaluator information, and thus a confidence level of the evaluation can be obtained based on at least one of the determined field expertise level or the determined interest level.

Moreover, an information processing method according to example 2 is the information processing method according to example 1, and may be an information processing method in which (i) in the determining, the at least one of the field expertise level or the conflict of interest level of the evaluator is determined for each of a plurality of evaluation targets, where the plurality of evaluation targets each being the evaluation target, and (ii) in the deriving, the confidence level is derived for each of the plurality of evaluation targets.

As described above, a confidence level of the evaluation for each of evaluation targets can be obtained by determining at least one of the field expertise level or the conflict of interest level of the evaluator for each of the evaluation targets.

In addition, an information processing method according to example 3 is the information processing method according to example 1 or 2, and may be an information processing method in which (i) in the determining, each of the field expertise level and the conflict of interest level of the evaluator is determined based on the evaluation target information and the evaluator information, and (ii) in the deriving, the confidence level is derived based on the field expertise level and the conflict of interest level.

As described above, the confidence level of the evaluation can be even more appropriately obtained by deriving the confidence level based on both of the field expertise level and the conflict of interest level.

Moreover, an information processing method according to example 4 is the information processing method according to example 3, and may be an information processing method in which, in the deriving, the confidence level is derived by weighting each of the field expertise level and the conflict of interest level.

As described above, the confidence level of the evaluation can be even more appropriately obtained by weighting each of the field expertise level and the conflict of interest level.

In addition, an information processing method according to example 5 is the information processing method according to any one of examples 1 to 4, and may be an information processing method in which, in the deriving, the confidence level is derived based on Equation 1 that is T=αS−βI, where T denotes the confidence level, S denotes the field expertise level, I denotes the conflict of interest level, α denotes a coefficient greater than or equal to 0, and β denotes a coefficient greater than or equal to 0.

The confidence level of the evaluation can be even more appropriately obtained by using the above Equation 1.

Moreover, an information processing method according to example 6 is the information processing method according to any one of examples 1 to 5, and may be an information processing method in which the evaluation target is a theme of research and development on which a company that the evaluator belongs to invests for a future.

According to the above, a confidence level of an evaluation that is to be performed or has been performed on a theme of research and development by an evaluator can be obtained.

In addition, an information processing method according to example 7 is the information processing method according to any one of examples 1 to 6, and may be an information processing method in which, in the determining, the field expertise level is determined based on a relationship between a search expression to search for literature about the evaluation target and literature whose inventor or author is the evaluator.

According to the above, a field expertise level of an evaluator on an evaluation target can be appropriately determined. With this, the confidence level of the evaluation can be even more appropriately obtained.

Moreover, an information processing method according to example 8 is the information processing method according to any one of examples 1 to 7, and may be an information processing method in which the literature is at least one of patent literature or a paper.

According to the above, a field expertise level can be appropriately determined based on at least one of patent literature or a paper. With this, the confidence level of the evaluation can be even more appropriately obtained.

In addition, an information processing method according to example 9 is the information processing method according to any one of examples 1 to 8, and may be an information processing method in which, in the determining, the conflict of interest level is determined based on a relationship between a research and development organization that has brought up the evaluation target and each of past and present organizational affiliations of the evaluator.

According to the above, the conflict of interest level of an evaluator on an evaluation target can be appropriately determined. With this, the confidence level of the evaluation can be even more appropriately obtained.

Moreover, an information processing method according to example 10 is the information processing method according to any one of examples 1 to 9, and may be an information processing method that further includes determining adoption or non-adoption of an evaluation performed on the evaluation target by a given evaluator, and in which, in the determining of adoption or non-adoption of the evaluation, adoption of the evaluation performed on the evaluation target by the given evaluator is determined when the confidence level is greater than a predetermined threshold.

According to the above, adoption of an evaluation performed on an evaluation target by a given evaluator can be determined, when the above confidence level is greater than a given threshold. With this, an evaluation target can be appropriately evaluated.

In addition, an information processing method according to example 11 is the information processing method according to any one of examples 1 to 9, and may be an information processing method that further includes correcting an evaluation performed on the evaluation target by a given evaluator, and in which, in the correcting, the evaluation is corrected by weighting, using the confidence level, the evaluation performed on the evaluation target by the given evaluator.

According to the above, the evaluation of an evaluation target can be corrected using the above confidence level. With this, an evaluation target can be appropriately evaluated.

An information processing system according to example 12 is an information processing system that derives a confidence level of an evaluation that is to be performed or has been performed on an evaluation target by an evaluator. The information processing system includes: a target information obtainer that obtains evaluation target information containing information about the evaluation target; an evaluator information obtainer that obtains evaluator information containing information about the evaluator; a level determiner that determines, based on the evaluation target information and the evaluator information, at least one of a field expertise level or a conflict of interest level of the evaluator on the evaluation target; and a confidence level deriver that derives the confidence level of the evaluation based on the at least one of the field expertise level or the conflict of interest level which have been determined by the level determiner.

As described above, at least one of a field expertise level or a conflict of interest level of an evaluator on an evaluation target is determined based on evaluation target information and evaluator information, to obtain the above confidence level of the evaluation based on at least one of the field expertise level or the conflict of interest level.

A recording medium according to example 13 is a non-transitory computer-readable recording medium for use in a computer. The recording medium has recorded thereon a computer program for causing the computer to execute the information processing method according to any one of examples 1 to 11.

With this, it is possible to cause a computer to execute the above-described information processing method according to a non-transitory computer-readable recording medium on which the above-described program is recorded.

Note that these general or specific aspects may be realized using a system, a device, a method, an integrated circuit, a computer program, or a non-transitory recording medium such as a computer-readable CD-ROM, or any combination of systems, devices, methods, integrated circuits, computer programs, and recording media.

Hereinafter, embodiments will be described with reference to the drawings. Note that each of the exemplary embodiments described below shows a general or specific example. The numerical values, shapes, materials, elements, the arrangement and connection of the elements, steps, the orders of the steps etc. shown in the following exemplary embodiments are mere examples, and therefore do not limit the scope of the appended Claims and their equivalents.

### EMBODIMENT

### [Configuration of Information Processing System]

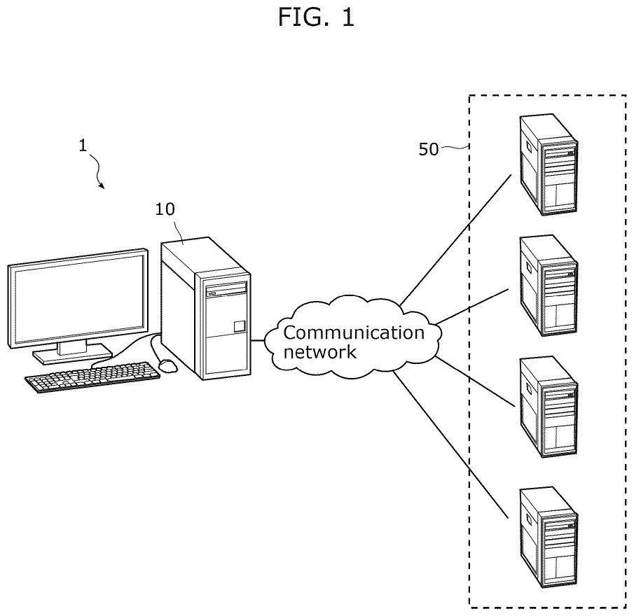

A configuration of information processing system according to an embodiment will be described with reference to FIG. 1 through FIG. 7.

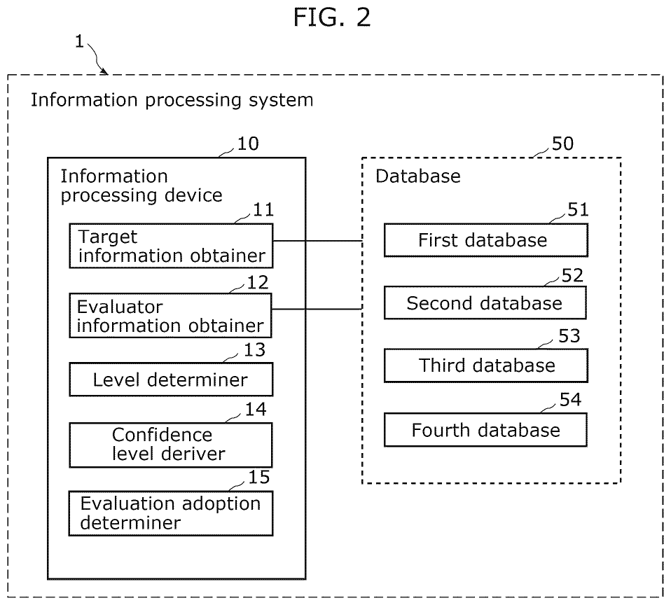

FIG. 1 is a schematic diagram illustrating information processing system 1 according to an embodiment. FIG. 2 is a block diagram illustrating a configuration of information processing system 1 and information processing device 10 included in information processing system 1.

As illustrated in FIG. 1 and FIG. 2, information processing system 1 includes information processing device 10 and database 50. Information processing device 10 and database 50 are connected with each other via a communication network.

Database 50 is, for example, a computer device. Database 50 receives, outputs, edits, and stores various types of information. Note that database 50 also includes an external storage device such as a network attached storage (NAS).

Database 50 includes first database 51 and second database 52. First database 51 and second database 52 are provided inside a facility managed by a company to which an evaluator belongs, for example. First database 51 is, for example, a technical project database, and stores information about evaluation targets. Second database 52 is, for example, a human resources database, and stores information about evaluators.

Database 50 also includes third database 53 and fourth database 54. Third database 53 and fourth database 54 are provided in, for example, an external server on the Internet. Third database 53 is, for example, a patent literature database, and stores information about patent literature. Fourth database 54 is, for example, a paper database, and stores information about technical papers.

Information processing device 10 is capable of accessing database 50 to obtain necessary information.

As illustrated in FIG. 2, information processing device 10 includes target information obtainer 11, evaluator information obtainer 12, level determiner 13, confidence level deriver 14, and evaluation adoption determiner 15. Information processing device 10 is, for example, a computer device. Information processing device 10 receives and outputs various types of information and performs computation processing.

Target information obtainer 11 is a processing circuit that obtains evaluation target information i1. Target information obtainer 11 obtains evaluation target information i1 based on information about an evaluation target output from database 50.

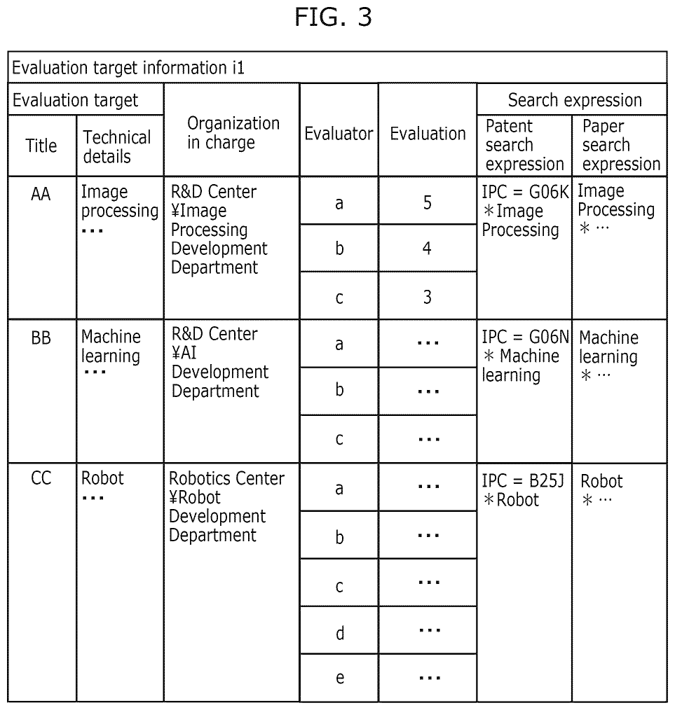

FIG. 3 is a diagram illustrating one example of evaluation target information i1 obtained by information processing device 10.

Evaluation target information i1 contains information about the titles of evaluation targets, details of the evaluation targets, and organizations in charge of the evaluation targets. For example, the title of an evaluation target is the title of a theme of research and development, and the details of the evaluation target are technical details of the research and development theme. Hereinafter, the embodiment will be described using an example of the case where an evaluation target is a theme of research and development. An organization in charge is an organization that brings up an evaluation target and carries out the evaluation target. Information about an organization in charge is stored in a hierarchical format in which a plurality of small organizations are associated with a large organization, like, for example, the research and development center, research and development department, development division, and so on. The information about an organization in charge also contains organizational history information indicating relationships between the present organization and past organizations.

In addition, evaluation target information i1 contains evaluators who perform evaluations on evaluation targets, and results of evaluations that are to be performed or have been performed on the evaluation targets by the evaluators. An evaluator evaluates each of the evaluation targets. Moreover, an evaluation on an evaluation target is performed by each of the evaluators.

Each evaluator gives evaluation points on evaluation items, such as the customer appeal level, project size, and level of differentiation from competitors, and determines the evaluation point for an evaluation target by, for example, calculating the average of weights as appropriate. An evaluation of an evaluation target is performed when a theme of research and development is applied, but the evaluation may be performed, for example, when a project on the theme of research and development is completed, at times the progress of the theme of research and development is monitored on a regular basis, and when the budget is under review.

Evaluation target information i1 also contains search expressions to search for literature about evaluation targets. The search expressions are, for example, patent search expressions or paper search expressions.

The patent search expressions are classifications or keywords used when research on patent literature is carried out, such as the International Patent Classification (IPC) and File Forming Term (F-Term). The paper search expressions are classifications or keywords used when research on papers is carried out. Technical classifications (the All Science Journal Classification (ASJC)) given in paper databases, such as SCOPUS (registered trademark), may be used for the paper search expressions.

Note that when the above-described search expressions are not contained in information about evaluation targets which is stored in first database 51, target information obtainer 11 may obtain patent search expressions and paper search expressions based on technical details of the evaluation targets. For example, each patent search expression includes a keyword included in technical details and a patent classification (e.g., IPC) including the keyword. For example, each paper search expression includes a keyword included in technical details and a technical classification (e.g., ASJC) including the keyword. These search expressions may be obtained by automatic computation processing performed by information processing device 10. Evaluation target information i1 obtained by target information obtainer 11 is output to level determiner 13. Level determiner 13 will be described later in the embodiment.

Evaluator information obtainer 12 is a processing circuit that obtains evaluator information i2. Evaluator information obtainer 12 obtains evaluator information i2 based on information about an evaluator output from database 50.

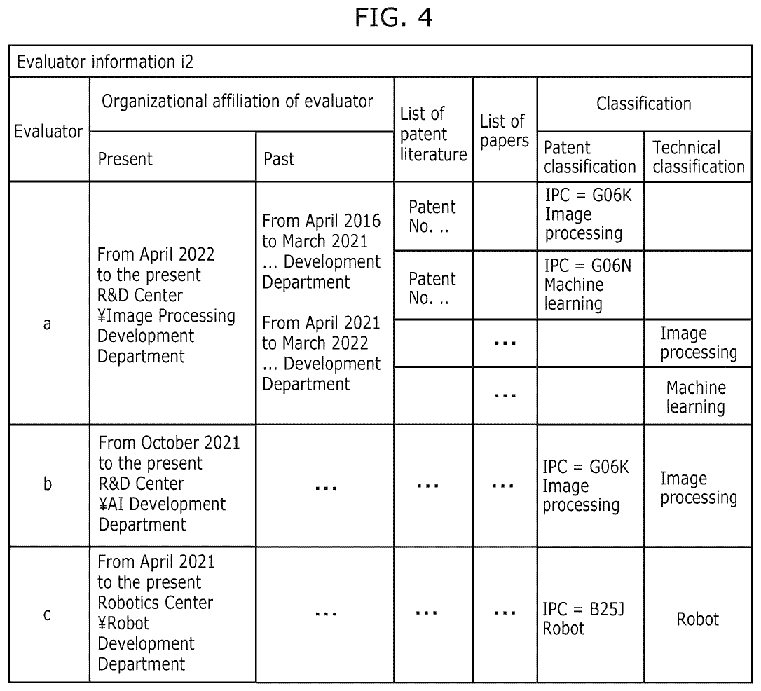

FIG. 4 is a diagram illustrating one example of evaluator information i2 obtained by information processing device 10.

Evaluator information i2 contains the identification information and organizational affiliations of evaluators. For example, the identification information of the evaluators is the name and employee identification number of each of the evaluators. The organizational affiliations of the evaluators are past and the present organizational affiliations of each evaluator. The organizational affiliations are internal organizations of a company to which each evaluator belongs, and are stored in a hierarchical format, like the research and development center, research and development department, development division, and so on. The organizational affiliations of each evaluator are used to determine the conflict of interest level of the evaluator on an evaluation target.

Evaluator information i2 also contains information about literature whose inventor or author is an evaluator, namely patent literature and papers (non-patent literature). Literature whose inventor or author is an evaluator may be hereafter called evaluator literature. The evaluator literature may include literature written by an evaluator in the past, namely literature written when the evaluator did not belong to the company. The papers may also include internal papers, technical reports, and the like which are disclosed solely in the company.

Patent literature of an evaluator is given a patent classification (e.g., IPC) and a paper of an evaluator is given a technical classification (e.g., ASJC). Evaluator information i2 stores the list of patent literature of each evaluator to which classifications are given and the list of papers of each evaluator to which classifications are given. These lists are used to determine the field expertise level of each evaluator on an evaluation target.

Note that when the above-described classifications are not contained in information about evaluators which is stored in second database 52, evaluator information obtainer 12 may obtain, based on evaluator literature, patent classifications or technical classifications corresponding to the evaluator literature. For example, as for patent classifications, patent classifications indicated in patent literature may be referred, and as for technical classifications, technical classifications given to a paper may be referred. These classifications may be obtained by automatic computation processing performed by information processing device 10. Evaluator information i2 obtained by evaluator information obtainer 12 is output to level determiner 13.

Level determiner 13 is a processing circuit that determines at least one of field expertise level S or conflict of interest level I of an evaluator on an evaluation target, based on evaluation target information i1 and evaluator information i2. Field expertise level S and conflict of interest level I are necessary determination items to derive confidence level T of an evaluation. Hereinafter, each of field expertise level S and conflict of interest level I will be described.

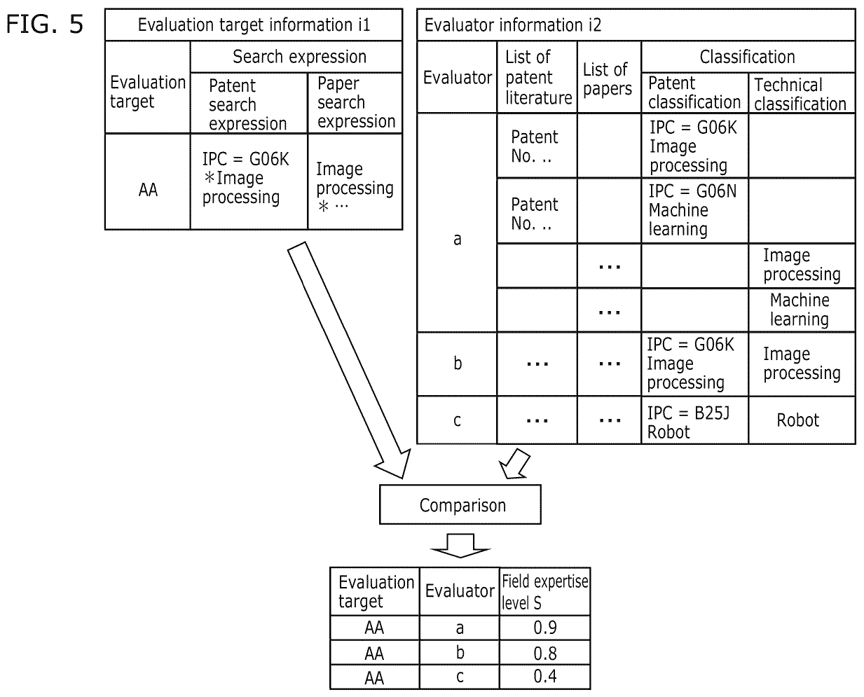

FIG. 5 is a diagram illustrating one example of field expertise level S determined by information processing device 10.

Field expertise level S indicates the level of expertise of an evaluator in the technical field of an evaluation target. Field expertise level S differs depending on differences in expertise of evaluator a on evaluation targets AA, BB, and CC. Among evaluation targets AA, BB, and CC, evaluation target AA is hereafter used as a representative example to describe the embodiment.

As illustrated in FIG. 5, field expertise level S also differs depending on evaluators a, b, and c who evaluate evaluation target AA. Field expertise level S indicated in a larger value indicates greater expertise, and is indicated in 11 levels (0, 0.1, 0.2, 0.3, 0.4, 0.5, 0.6, 0.7, 0.8, 0.9, 1.0) from 0 to 1.0, for example. FIG. 5 shows an example in which field expertise level S of evaluator a on evaluation target AA is 0.9, field expertise level S of evaluator b on evaluation target AA is 0.8, and field expertise level S of evaluator c on evaluation target AA is 0.4. Note that field expertise level S is not limited to 11 levels. Field expertise level S may be indicated in two or more levels.

As described above, evaluation target information i1 contains search expressions to search for literature about evaluation targets, and evaluator information i2 contains classifications of literature whose inventors or authors are evaluators. Level determiner 13 determines field expertise level S based on the relationships between the above-described search expressions and evaluator literature.

For example, level determiner 13 determines field expertise level S based on degrees of connections between the above-described search expressions and classifications of evaluator literature. More specifically, level determiner 13 compares each of the above-described patent search expressions with each of patent classifications indicated in patent literature of an evaluator, and determines that the degrees of connections are higher for matches made between hierarchically lower levels among levels (section, class, subclass, main group, subgroup, so on). Moreover, level determiner 13 compares each of the above-described paper search expressions with each of technical classifications indicated in a paper of the evaluator, and determines that the degrees of connections are higher for matches made between hierarchically lower levels among the levels. Thereafter, level determiner 13 determines field expertise level S is high when the degrees of connections between the above-described search expressions and the classifications of evaluator literature are high. Alternatively, level determiner 13 determines field expertise level S is low when the degrees of connections are low. Information about field expertise level S determined by level determiner 13 is output to confidence level deriver 14.

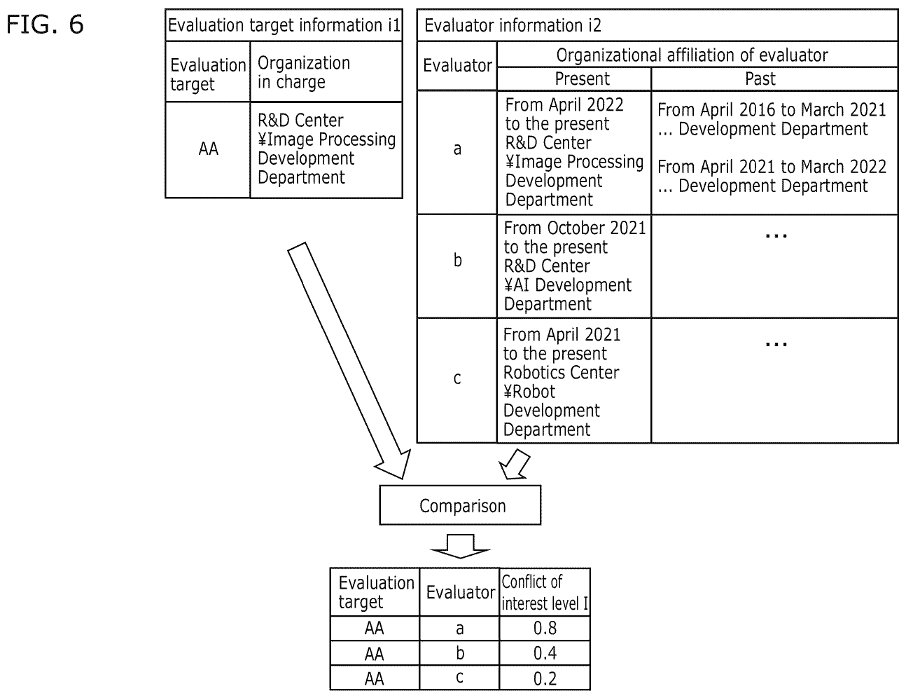

FIG. 6 is a diagram illustrating one example of conflict of interest level I determined by information processing device 10.

Conflict of interest level I is a level indicating the degree of conflict of interest of an evaluator with an organization in charge that has brought up an evaluation target. Conflict of interest level I differs depending on a combination between (i) each of organizations in charge that have brought up respective evaluation targets AA, BB, and CC and (ii) each of past and present organizational affiliations of respective evaluators a, b, and c. Conflict of interest level I indicated in a larger value indicates a higher degree of conflict of interest, and is indicated in 11 levels (0, 0.1, 0.2, 0.3, 0.4, 0.5, 0.6, 0.7, 0.8, 0.9, 1.0) from 0 to 1.0, for example. FIG. 6 shows an example in which conflict of interest level I of evaluator a on evaluation target AA is 0.8, conflict of interest level I of evaluator b on evaluation target AA is 0.4, and conflict of interest level I of evaluator c on evaluation target AA is 0.2. Note that conflict of interest level I is not limited to 11 levels. Conflict of interest level I may be indicated in two or more levels.

As described above, evaluation target information i1 contains information about organizations in charge that have brought up evaluation targets, and evaluator information i2 contains information about present and past organizational affiliations of evaluators. Level determiner 13 determines conflict of interest level I based on the relationships between an organization in charge that has brought up an evaluation target and organizational affiliations of an evaluator.

For example, level determiner 13 determines conflict of interest level I based on degrees of connections between an organization in charge that has brought up an evaluation target and organizational affiliations of an evaluator. More specifically, level determiner 13 compares the organization in charge that has brought up an evaluation target with each of the organizational affiliations of the evaluator, and determines that the degrees of connections are higher for matches made between hierarchically lower levels among the levels (the research and development center, research and development department, development division, and so on). Thereafter, level determiner 13 determines conflict of interest level I is high when the degrees of connections between the organization in charge that has brought up an evaluation target and the organizational affiliations of the evaluator are high. Alternatively, level determiner 13 determines conflict of interest level I is low when the degrees of connections are low. Information about conflict of interest level I determined by level determiner 13 is output to confidence level deriver 14.

Confidence level deriver 14 is a processing circuit that derives confidence level T of an evaluation that is to be performed or has been performed by an evaluator, based on at least one of field expertise level S or conflict of interest level I determined by level determiner 13.

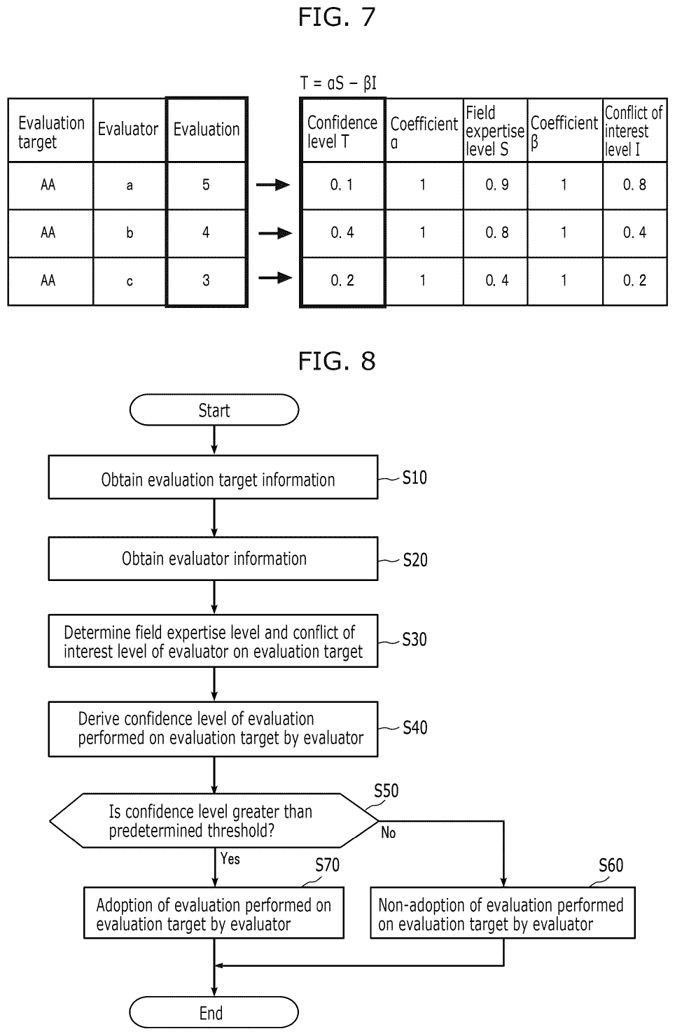

FIG. 7 is a diagram illustrating one example of confidence level T derived by information processing device 10.

Confidence level T is a confidence level of an evaluation that is to be performed or has been performed on an evaluation target by an evaluator. Confidence level deriver 14 derives confidence level T by weighting each of field expertise level S and conflict of interest level I. Confidence level T indicates a higher confidence level for a larger value, and is indicated by a level of from 0 to 1.0. In deriving of confidence level T, field expertise level S is a positive factor and conflict of interest level I is a negative factor.

For example, confidence level deriver 14 derives confidence level T based on the following Equation 1, where T denotes confidence level, S denotes field expertise level, I denotes interest level, a denotes a coefficient greater than or equal to 0, and β denotes a coefficient greater than or equal to 0.

T=αS−βI (Equation 1)

FIG. 7 shows an example in which confidence level T of an evaluation performed on evaluation target AA by evaluator a is 0.1, confidence level T of an evaluation performed on evaluation target AA by evaluator b is 0.4, and confidence level T of an evaluation performed on evaluation target AA by evaluator c is 0.2. Note that coefficients α and β are both preset as 1 as expressed by α=β=1.

Coefficients α and β are preset in information processing device 10 depending on which one of field expertise level S and conflict of interest level I is to be placed greater emphasis. For example, when the weight of field expertise level S is to be twice the weight of conflict of interest level I, coefficient α is 1 (α=1) and coefficient β is 0.5 (β=0.5), and when the weight of field expertise level S is to be half the weight of conflict of interest level I, coefficient α is 0.5 (α=0.5) and coefficient β is 1 (β=1). Moreover, when confidence level T is to be derived based on only field expertise level S, coefficient β is 0 (β=0), and when confidence level T is to be derived based on only conflict of interest level I, coefficient α is 0 (α=0).

In the above, evaluation target AA has been used as an example to describe the embodiment, but confidence level T of an evaluation performed by an evaluator can be derived for evaluation targets BB and CC in the same manner as described above. Confidence level T derived by confidence level deriver 14 is output to evaluation adoption determiner 15.

Evaluation adoption determiner 15 is a processing circuit that determines adoption or non-adoption of an evaluation that is performed on an evaluation target by a given evaluator. When confidence level T is greater than a predetermined threshold, evaluation adoption determiner 15 determines adoption of an evaluation that is performed on an evaluation target by a given evaluator.

For example, when the above-mentioned threshold is set to 0.3, evaluation adoption determiner 15 determines non-adoption of the evaluations performed on evaluation target AA by evaluators a and c in the example shown in FIG. 7. Meanwhile, evaluation adoption determiner 15 determines adoption of the evaluation performed on evaluation target AA by evaluator b. According to the above, an evaluation of an evaluation target can be appropriately performed.

Information processing system 1 according to the embodiment includes target information obtainer 11 that obtains evaluation target information i1, evaluator information obtainer 12 that obtains evaluator information i2, level determiner 13 that determines, based on evaluation target information i1 and evaluator information i2, at least one of field expertise level S or conflict of interest level I, and confidence level deriver 14 that derives confidence level T of the evaluation based on the at least one of field expertise level S or conflict of interest level I which have been determined by level determiner 13. With this configuration, confidence level T of an evaluation that is to be performed or has been performed on an evaluation target by an evaluator can be appropriately obtained.

Note that although the above exemplified the case where an evaluation performed on an evaluation target by a given evaluator is adopted when confidence level T is greater than a predetermined threshold, the adoption of an evaluation is non-limiting. For example, evaluation adoption determiner 15 may determine non-adoption of an evaluation performed on an evaluation target by a given evaluator when field expertise level S is less than a predetermined threshold (e.g., 0.5). For example, evaluation adoption determiner 15 may determine non-adoption of an evaluation performed on an evaluation target by a given evaluator when conflict of interest level I is greater than or equal to a predetermined threshold (e.g., 0.7).

### [Information Processing Method]

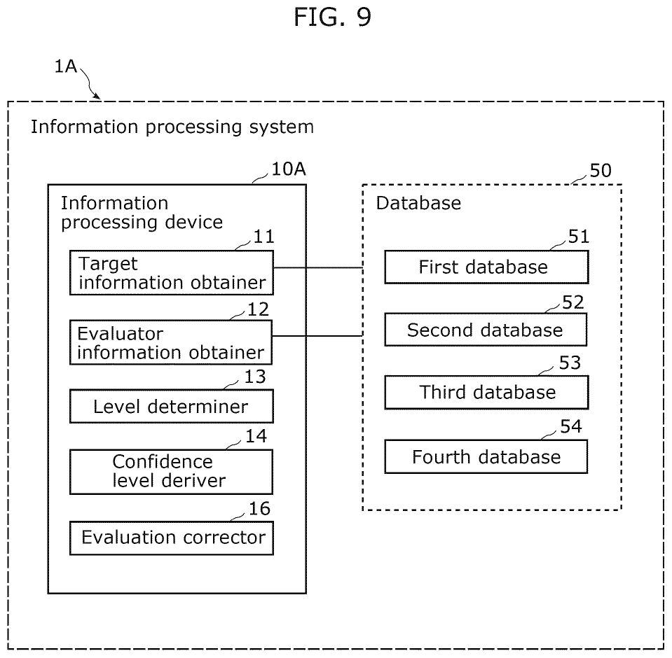

An information processing method according to the embodiment will be described with reference to FIG. 8.

FIG. 8 is a flowchart illustrating an information processing method according to the embodiment.

Information processing device 10 obtains evaluation target information i1 containing information about evaluation targets (step S10). For example, information processing device 10 obtains evaluation target information i1 based on information obtained from first database 51, third database 53, and fourth database 54.

Evaluation target information i1 contains the titles of the evaluation targets, details of the evaluation targets, and organizations in charge of the evaluation targets. The evaluation targets each are a theme of research and development on which a company that an evaluator belongs to invests for the future, for example. Moreover, evaluation target information i1 contains evaluators who perform evaluations on the evaluation targets, and results of the evaluations performed on the evaluation targets by the evaluators. Evaluation target information i1 also contains search expressions to search for literature about the evaluation targets (themes of research and development). The search expressions are, for example, patent search expressions or paper search expressions.

Next, information processing device 10 obtains evaluator information i2 containing information about the evaluators (step S20). For example, information processing device 10 obtains evaluator information i2 based on information obtained from second database 52, third database 53, and fourth database 54.

Evaluator information i2 contains the identification information and organizational affiliations of the evaluators. Moreover, evaluator information i2 contains information about literature whose inventors or authors are the evaluators, namely patent literature and papers (non-patent literature). Note that steps S10 and S20 are not in particular order, and may be simultaneously performed.

Next, information processing device 10 determines, based on evaluation target information i1 and evaluator information i2, at least one of field expertise levels S or interest levels I of the evaluators on the evaluation targets (step S30). For example, information processing device 10 determines field expertise level S based on the relationship between a search expression to search for literature about an evaluation target and literature whose inventor or author is an evaluator. In addition, information processing device 10 determines conflict of interest level I based on the relationship between a research and development organization that has brought up an evaluation target and each of past and present organizational affiliations of an evaluator.

Information processing device 10 determines, for each of the evaluation targets, field expertise level S and conflict of interest level I of an evaluator. When a plurality of evaluators are present, field expertise level S and conflict of interest level I of each evaluator who has performed an evaluation on one evaluation target are determined. Information processing device 10 may determine both of field expertise level S and interest level of an evaluator or one of field expertise level S or interest level of the evaluator, based on evaluation target information i1 and evaluator information i2.

Next, information processing device 10 derives confidence levels T of the evaluations that are to be performed or have been performed by the evaluators, based on at least one of field expertise levels S or interest levels I determined in step S30 (step S40). For example, information processing device 10 derives confidence level T by weighting each of field expertise level S and conflict of interest level I.

Next, adoption or non-adoption of an evaluation performed on an evaluation target by a given evaluator is determined. Specifically, information processing device 10 determines whether confidence level T is greater than a predetermined threshold (step S50). When confidence level T is less than or equal to the predetermined threshold (No in S50), information processing device 10 determines non-adoption of the evaluation performed on the evaluation target by the given evaluator (step S60). Meanwhile, when confidence level T is greater than the predetermined threshold (Yes in S50), information processing device 10 determines adoption of the evaluation performed on the evaluation target by the given evaluator (step S70).

Execution of the above-described steps S10 through S40 allows confidence level T of an evaluation that is performed on an evaluation target by an evaluator to be obtained. Furthermore, execution of steps S50 through S70 allows an evaluation of an evaluation target to be appropriately performed.

### VARIATION OF EMBODIMENT

Information processing system 1A according to a variation of the embodiment will be described. This variation describes an example of correcting an evaluation performed by an evaluator using confidence level T that is derived through the above-described method.

FIG. 9 is a block diagram illustrating a configuration of information processing system 1A according to the variation of the embodiment.

As illustrated in FIG. 9, information processing system 1A includes information processing device 10A and database 50. Information processing device 10A includes target information obtainer 11, evaluator information obtainer 12, level determiner 13, confidence level deriver 14, and evaluation corrector 16.

Evaluation corrector 16 is a processing circuit that corrects an evaluation performed on an evaluation target by a given evaluator. Evaluation corrector 16 corrects the evaluation by weighting, using confidence level T derived by confidence level deriver 14, an evaluation that is performed on an evaluation target by a given evaluator. With this element, evaluation of an evaluation target can be appropriately performed.

Note that evaluation corrector 16 may average evaluation points given by a plurality of evaluators to determine the overall evaluation point for an evaluation target. Moreover, evaluation corrector 16 may remove the highest evaluation point and the lowest evaluation point from among the evaluation points given by the plurality of evaluators and may average remaining evaluation points to determine the overall evaluation point for the evaluation target.

An information processing method according to the variation of the embodiment will be described.

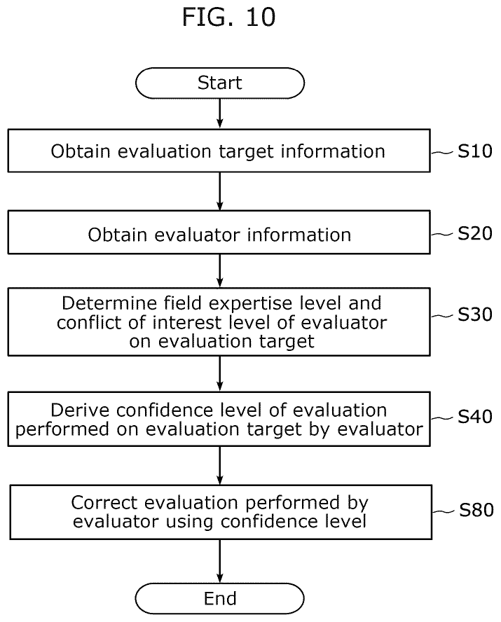

FIG. 10 is a flowchart illustrating an information processing method according to the variation of the embodiment.

Steps S10 through S40 are the same as the steps S10 through S40 described in the embodiment.

In the variation, a correction of an evaluation that has been performed on an evaluation target by a given evaluator is performed (step S80). More specifically, information processing device 10 corrects the evaluation by weighting, using confidence level T derived in step S40, the evaluation that is performed on the evaluation target by the given evaluator. Execution of step S80 allows an evaluation of an evaluation target to be appropriately performed.

### OTHER EMBODIMENTS

Hereinbefore, aspects of the information processing system and the like have been described according to the embodiments, but the aspects of the information processing system and the like are not limited to the embodiments. Variations conceivable to those skilled in the art may be applied to the embodiments, and a plurality of elements in the embodiments may be optionally combined.

For example, information processing device 10 may include an evaluator determiner that determines whether a given person is to be the evaluator of an evaluation target, and the evaluator determiner may determine that the given person is not to be the evaluator when field expertise level S of the given person is less than a given threshold. Moreover, the evaluator determiner may determine the given person is not to be the evaluator when conflict of interest level I of the given person is greater than or equal to the given threshold.

For example, a process performed by a particular element in the embodiments may be performed by a different element instead of the particular element. In addition, the order of a plurality of processes may be changed, and the plurality of processes may be performed in parallel. Furthermore, ordinal numbers such as first and second used for description of the embodiments may be appropriately exchanged, removed, or newly added. These ordinal numbers do not necessarily correspond to significant order, and may be used to distinguish between elements.

The information processing method may be implemented by an optional system or an optional device. To be more specific, the information processing method may be executed by the above-described information processing system and the like, or may be executed by other systems or devices.

For example, some or the entirety of information processing method may be implemented by a computer that includes a processor, memory, input/output circuit, etc. In this case, the information processing method may be implemented by the computer executing a program for causing the computer to implement the information processing method.

Moreover, the above-described program may be recorded on a non-transitory computer-readable recording medium such as a CD-ROM.

Each of the elements included in the information processing system and the like may be configured as a dedicated hardware product, a general-purpose hardware product that executes the above-described program, etc., or a combination thereof. The general-purpose hardware product may include a memory on which a program is recorded, a general-purpose processor that executes by reading the program from the memory, etc. Here, the memory may be a semiconductor memory, a hard disk, or the like, and the general-purpose processor may be the central processing unit (CPU) or the like.

The dedicated hardware product may include a memory, a dedicated processor, etc. For example, the dedicated processor may execute the above-described information processing method by referring to the memory.

Each of the elements included in the information processing system may be an electric circuit. These electric circuits may constitute a single circuit as a whole or may be individual circuits. These electric circuit each may be compatible with a dedicated hardware product or may be compatible with a general-purpose hardware product that executes the above-described program and the like.

### INDUSTRIAL APPLICABILITY

The present disclosure is applicable to, for example, confidence level deriving methods of obtaining a confidence level of an evaluation that is to be performed or has been performed on a theme of research and development by an evaluator.

1. An information processing method of deriving a confidence level of an evaluation that is to be performed or has been performed on an evaluation target by an evaluator, the information processing method comprising:
obtaining evaluation target information containing information about the evaluation target;
obtaining evaluator information containing information about the evaluator;
determining, based on the evaluation target information and the evaluator information, at least one of a field expertise level or a conflict of interest level of the evaluator on the evaluation target; and
deriving the confidence level of the evaluation based on the at least one of the field expertise level or the conflict of interest level which have been determined in the determining.

2. The information processing method according to claim 1, wherein
in the determining, the at least one of the field expertise level or the conflict of interest level of the evaluator is determined for each of a plurality of evaluation targets, the plurality of evaluation targets each being the evaluation target, and
in the deriving, the confidence level is derived for each of the plurality of evaluation targets.

3. The information processing method according to claim 1, wherein
in the determining, each of the field expertise level and the conflict of interest level of the evaluator is determined based on the evaluation target information and the evaluator information, and
in the deriving, the confidence level is derived based on the field expertise level and the conflict of interest level.

4. The information processing method according to claim 3, wherein
in the deriving, the confidence level is derived by weighting each of the field expertise level and the conflict of interest level.

5. The information processing method according to claim 1, wherein
in the deriving, the confidence level is derived based on Equation 1 that is T=αS−βI, where T denotes the confidence level, S denotes the field expertise level, I denotes the conflict of interest level, α denotes a coefficient greater than or equal to 0, and β denotes a coefficient greater than or equal to 0.

6. The information processing method according to claim 1, wherein
the evaluation target is a theme of research and development on which a company that the evaluator belongs to invests for a future.

7. The information processing method according to claim 1, wherein
in the determining, the field expertise level is determined based on a relationship between a search expression to search for literature about the evaluation target and literature whose inventor or author is the evaluator.

8. The information processing method according to claim 7, wherein
the literature is at least one of patent literature or a paper.

9. The information processing method according to claim 6, wherein
in the determining, the conflict of interest level is determined based on a relationship between a research and development organization that has brought up the evaluation target and each of past and present organizational affiliations of the evaluator.

10. The information processing method according to claim 1, further comprising:
determining adoption or non-adoption of an evaluation performed on the evaluation target by a given evaluator, wherein
in the determining of adoption or non-adoption of the evaluation, adoption of the evaluation performed on the evaluation target by the given evaluator is determined when the confidence level is greater than a predetermined threshold.

11. The information processing method according to claim 1, further comprising:
correcting an evaluation performed on the evaluation target by a given evaluator, wherein
in the correcting, the evaluation is corrected by weighting, using the confidence level, the evaluation performed on the evaluation target by the given evaluator.

12. An information processing system that derives a confidence level of an evaluation that is to be performed or has been performed on an evaluation target by an evaluator, the information processing system comprising:
a target information obtainer that obtains evaluation target information containing information about the evaluation target;
an evaluator information obtainer that obtains evaluator information containing information about the evaluator;
a level determiner that determines, based on the evaluation target information and the evaluator information, at least one of a field expertise level or a conflict of interest level of the evaluator on the evaluation target; and
a confidence level deriver that derives the confidence level of the evaluation based on the at least one of the field expertise level or the conflict of interest level which have been determined by the level determiner.

13. A non-transitory computer-readable recording medium for use in a computer, the recording medium having recorded thereon a computer program for causing the computer to execute the information processing method according to claim 1.
